(19) United States
(12) Patent Application Publication
(10) Pub. No.: US 2012/0059082 A1
(43) Pub. Date: Mar. 8, 2012

(54) Biodegradable and Sustainable Fragranced Polymer Systems

(76) Inventors: Franklin Albert Pringgosusanto, Laurence Harbor, NJ (US); Lewis Michael Popplewell, Morganville, NJ (US); Michael Vincent Imperiale, Bloomfield, NJ (US)

(21) Appl. No.: 12/877,558

(22) Filed: Sep. 8, 2010

(51) Int. Cl. C08L 1/12; C08L 1/00; C08K 5/00

(52) U.S. Cl. 523/102

(57) ABSTRACT

The present invention is directed to a biodegradable fragrance polymer system and a sustainable fragrance polymer system.

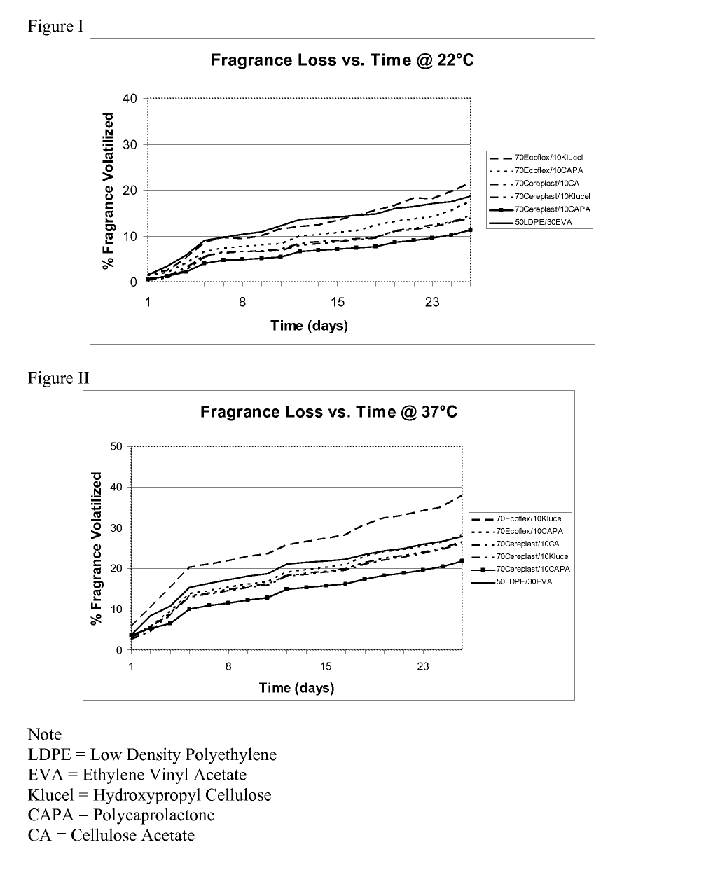

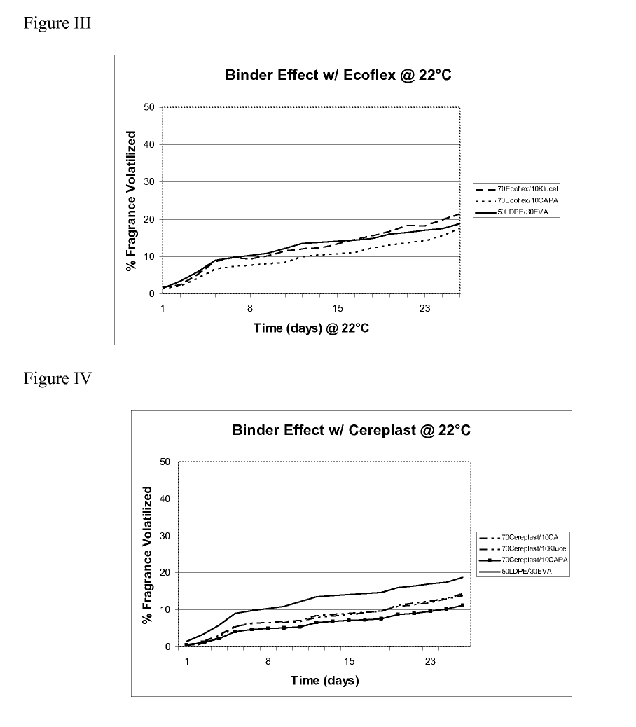

### FIELD OF THE INVENTION

The present invention is directed to a biodegradable fragrance polymer system and a sustainable fragrance polymer system.

### BACKGROUND OF THE INVENTION

Fragranced polymers are well known and are normally composed of polymers that are not biodegradable or sustainable. Examples of fragranced polymers can be found in U.S. Pat. Nos. 4,428,869; 4,521,541; 6,207,514; 6,213,409, 6,500,444 and 7,105,064. The prior art does not disclose the use biodegradable or sustainable polymers in fragranced polymers. As described in the patents, the art of polymer extrusion has been widely known for many years. Fragranced polymers are normally produced by an extrusion process during which fragrance or flavor oil is introduced to the molten polymer in the extruder via an injection port using a pump. The extruder feeds an underwater pelletizer, a post extrusion process that allows pellets/beads to be formed as the final product.

There is an increasing demand for many plastic products to be biodegradable and sustainable. Based on this long felt need we have provided a biodegradable and sustainable fragranced polymer.

### SUMMARY OF THE INVENTION

The present invention is directed to a biodegradable fragranced polymer.

In one embodiment of the invention the biodegradable fragranced polymer contains a biodegradable or a compostable polymer, a biodegradable or a compostable binder material and a fragrance.

In yet another embodiment the volatilization of the fragrance contained in the biodegradable fragranced polymer is greater than 10%.

In another embodiment of the invention a sustainable fragranced polymer is provided that may comprise a biodegradable or sustainable polymer, a sustainable binder material and a fragrance.

In yet another embodiment the volatilization of the fragrance contained in the sustainable fragranced polymer is greater than 10%.

### BRIEF DESCRIPTION OF THE DRAWINGS

FIG. I: This figure illustrates the fragrance loss over time at 22° C. for various fragrances polymer systems.

FIG. II: This figure illustrates the fragrance loss over time at 37° C. for various fragrances polymer systems.

FIG. III: This figure illustrates the effectiveness of the binder material in combination with the biodegradable polymer.

FIG. IV: This figure illustrates the effectiveness of the binder material in combination with the biodegradable polymer.

### DETAILED DESCRIPTION OF THE INVENTION

Polymers that are certified as biodegradable or compostable and polymers that are certified as sustainable were investigated for use in the present invention. Biodegradable or compostable polymers are considered to be those that decompose in a recycling facility. Sustainable polymers are considered to be those that are manufactured using sustainable resources.

According to one embodiment of the invention, a biodegradable fragranced polymer system is provided that may contain a biodegradable polymer and a biodegradable binder material. Examples of biodegradable polymers are, but not limited to, Ecoflex an aliphatic-aromatic copolyester compound (BASF, USA), Cereplast Compostable 6001 a polylactic acid and starch compound (Cereplast, Calif.) and an example of a biodegradable binder material is Polycaprolactone (available as CAPA® from Perstorp, Sweden).

According to another embodiment, a sustainable fragranced polymer is provided that may comprise one of the biodegradable polymers listed above and a sustainable binder material and a fragrance. Example of sustainable binder polymers, include but are not limited to cellulose ester/acetate (Eastman) and Hydroxyproplyl Cellulose (available as Klucel® from Hercules, Del.).

A variation of combinations of the polymers listed in this application with a fragrance is contemplated by this invention.

FIG. I and FIG. II demonstrate that for this particular fragrance, the release profiles of Biodegradable PolyIFF's are quite similar to the current PolyIFF (50% Low Density Polyethylene/30% Ethylene Vinyl Acetate/20% oil). The figures indicate the fragrance volatilization in the fragrance polymer systems is greater than 10% over a period of 3 weeks.

FIG. III and IV compare different combinations of binder material mixed with two different biodegradable polymers. As FIGS. I and II suggest, systems using Cereplast Compostable 6001 are able to retain fragrance. The figures indicate the fragrance volatilization in the fragrance polymer systems is greater than 10% over a period of 3 weeks.

According to one embodiment of the invention, the fragrance polymers are produced as concentrated pellets or beads by using a twin screw extruder ZSK-26 (commercially available from made by the Coperion company) and an underwater pelletizer system (commercially available from Gala Industries, VA). Temperature condition used in the process may range from 100° C. to 150° C., with a preferred range between 110° C. and 130° C. The screw speed may be approximately set at 300 RPM.

The combination of biodegradable or compostable polymer can be combined with a binder material in the following ratios, from about equal parts 50 parts of biodegradable polymer and 50 parts biodegradable binder material; from about 99 parts of biodegradable polymer and about 1 parts binder material, more preferably 70 parts biodegradable polymer and 30 parts binder material and most preferably 85 parts 15 parts of binder material.

The combination of biodegradable or sustainable polymer can be combined with a sustainable binder material in the following ratios, from about equal parts 50 parts of biodegradable or sustainable polymer and 50 parts sustainable binder material; from about 99 parts of biodegradable or sustainable polymer and about 1 parts binder material, more preferably 70 parts biodegradable or sustainable polymer and 30 parts binder material and most preferably 85 parts biodegradable or sustainable polymer and 15 parts of binder material.

The fragrance loading for the fragranced polymer systems can be from about 0.01 weight percent up to 30 weight percent of the total system, preferably from about 5 weight percent up to 25 weight percent and more preferably from about 10 weight percent up to 20 weight percent.

### EXAMPLE I

The following combinations of polymers were produced:

1. 70% Ecoflex/10% CAPA/20% Fragrance.

2. 70% Ecoflex/10% Hydroxypropyl Cellulose/20%Fragrance

3. 60% Ecoflex/20% Cellulose Acetate/20% Fragrance.

4. 70% Cereplast/10% Cellulose Acetate/20%Fragrance.

5. 70% Cereplast/10% Hydroxypropyl Cellulose/20% Fragrance.

The fragrance used in these examples was Next of Skin, commercially available from International Flavors & Fragrances Inc. (New York, New York).

The fragrance polymer systems listed above were produced as concentrated pellets or beads by using a twin screw and a underwater pelletizer system. The experiment was carried out on a twin screw extruder ZSK-26 (commercially available from made by the Coperion company) equipped with sets of conveying and mixing screw elements that provide a significant amount of mixing in the barrel of the extruder. An oil injection port to add fragrance or flavor oil to the molten polymer is located on about the middle of the barrel. The temperature profile from the rear of the extruder to the die on the front of the extruder ranges from 110° C. to 130° C. After temperatures are reached, extruder screws were turned on to 300 RPM and resins are fed into the extruder. The underwater pelletizer (commercially available from Gala Industries, VA) cooled and cut the molten polymer coming out of the extruder to produce pellets about 3 mm in diameter. Different size pellets can be obtained by changing the speed at which the cutter rotates. Once the product was stable, the oil pump was turned on and the oil injection port was opened to allow fragrance/flavor to be mixed in the extruder.

What is claimed:

1. A biodegradable fragranced polymer comprising a biodegradable polymer, a biodegradable binder material and a fragrance.

2. The biodegradable fragranced polymer of claim 1 wherein the biodegradable polymer is selected from a polylactic acid and starch compound, an aliphatic-aromatic copolyester and combinations thereof.

3. The biodegradable fragranced polymer of claim 1 wherein the biodegradable binder material is polycaprolactone.

4. The biodegradable fragrance polymer of claim 1 wherein the ration of biodegradable polymer to biodegradable binder material is 99 parts to 1 part.

5. The biodegradable fragrance polymer of claim 1 wherein the ration of biodegradable polymer to biodegradable binder material is 70 parts to 30 parts.

6. The biodegradable fragrance polymer of claim 1 wherein the ration of biodegradable polymer to biodegradable binder material is 85 parts to 15 parts.

7. The biodegradable fragrance polymer of claim 1 wherein the fragrance volatilization is greater than 10% over a period of 3 weeks.

8. The biodegradable fragrance polymer of claim 1 wherein the fragrance volatilization is greater than 30% over a period of 3 weeks.

9. The biodegradable fragrance polymer of claim 1 wherein the fragrance volatilization is greater than 50% over a period of 3 weeks.

10. The biodegradable fragrance polymer of claim 1 wherein the fragrance volatilization is greater than 70% over a period of 3 weeks.

11. The biodegradable fragrance polymer of claim 1 wherein the fragrance volatilization is greater than 90% over a period of 3 weeks.

12. A sustainable fragranced polymer comprising a biodegradable polymer, a sustainable binder material and a fragrance.

13. The sustainable fragranced polymer of claim 13 wherein the biodegradable polymer is selected from a polylactic acid and starch compound.

14. The sustainable fragranced polymer of claim 13 wherein the sustainable binder material is selected from the group consisting of cellulose acetate, hydroxypropylcellulose and mixtures thereof.

15. The sustainable fragranced polymer of claim 13 wherein the ration of biodegradable polymer to biodegradable binder material is 99 parts to 1 part.

16. The sustainable fragranced polymer of claim 13 wherein the ration of biodegradable polymer to biodegradable binder material is 70 parts to 30 parts.

17. The sustainable fragranced polymer of claim 13 wherein the ration of biodegradable polymer to biodegradable binder material is 85 parts to 15 parts.

18. The sustainable fragranced polymer of claim 13 wherein the fragrance volatilization is greater than 10% over a period of 3 weeks.

19. The sustainable fragranced polymer of claim 13 wherein the fragrance volatilization is greater than 30% over a period of 3 weeks.

20. The sustainable fragranced polymer of claim 13 the fragrance volatilization is greater than 50% over a period of 3 weeks.

21. The sustainable fragranced polymer of claim 13 wherein the fragrance volatilization is greater than 70% over a period of 3 weeks.

22. The sustainable fragranced polymer of claim 13 wherein the fragrance volatilization is greater than 90% over a period of 3 weeks.
